(19) United States
(12) Patent Application Publication
(10) Pub. No.: US 2025/0068138 A1
(43) Pub. Date: Feb. 27, 2025

(54) MACHINING RESULT EVALUATION DEVICE, MACHINING RESULT EVALUATION METHOD, MACHINING CONDITION DETERMINATION DEVICE, AND MACHINING CONDITION DETERMINATION METHOD

(71) Applicant: Mitsubishi Electric Corporation, Tokyo (JP)

(72) Inventor: Kenta HAMADA, Tokyo (JP)

(73) Assignee: Mitsubishi Electric Corporation, Tokyo (JP)

(21) Appl. No.: 18/719,265

(22) PCT Filed: May 18, 2022
(86) PCT No.: PCT/JP2022/020704

§ 371 Date: Jun. 13, 2024

(51) Int. Cl. G05B 19/19

(52) U.S. Cl. CPC G05B 19/19; G05B 2219/33301; G05B 2219/34013

(57) ABSTRACT

An evaluation device for evaluating a result of machining includes a numerical control simulation unit that simulates a numerical control device, and outputs a position command to a drive shaft of the machine tool. Further, there is a servo control simulation unit that simulates the servo control device based on the position command and outputs a torque command to the drive shaft; a drive shaft simulation unit that simulates the drive shaft based on the torque command, and a machining result evaluation unit that evaluates a machining result based on information corresponding to an operation of the drive shaft. The drive shaft simulation unit outputs position information indicating a position of the drive shaft, the servo control simulation unit performs feedback control of the drive shaft simulation unit by using the position information, and the machining result evaluation unit evaluates a machining result obtained when the feedback control is simulated.

### FIELD

The present disclosure relates to a machining result evaluation device, a machining result evaluation method, a machining condition determination device, and a machining condition determination method for evaluating a machining result provided by a machine tool.

### BACKGROUND

In recent years, a machining simulation technique for a machining simulation device to evaluate a shape of a machined workpiece before a machine tool actually performs machining has been developed. This machining simulation device moves a tool on a virtual space in accordance with a machining program and removes a region through which the tool passes, from a machining target, or workpiece, to thereby evaluate a shape of the machined workpiece. In fact, it is often impossible for a machine tool to perform machining according to a machining program. For this reason, it is difficult for machining simulation based on the machining program to accurately evaluate a shape of a machined workpiece.

The machining simulation device described in Patent Literature 1 evaluates a shape of a machined workpiece by simulating an operation of a machine tool on the basis of a position command output by a numerical control device and transmission characteristics of the machine tool.

### CITATION LIST

### Patent Literature

Patent Literature 1: Japanese Patent Application Laid-open No. 2019-152936

### SUMMARY OF INVENTION

### Problem to be solved by the Invention

For the technique of Patent Literature 1 described above, unfortunately, machining is simulated without taking into consideration a response from the machine tool or a servo control device subsequent to the numerical control device, to the numerical control device. For this reason, the technique of Patent Literature 1 suffers from a problem of failure to simulate the processing corresponding to a function based on a return value of the response from the servo control device or the machine tool to the numerical control device. As a result, it is not possible for the technique of Patent Literature 1 to accurately evaluate a machining result.

The present disclosure has been made in view of the above, and an object thereof is to obtain a machining result evaluation device capable of accurately evaluating a machining result.

### Means to Solve the Problem

To solve the above problem and achieve the object, the present disclosure provides a machining result evaluation device to evaluate a machining result of machining by a machine tool driven by a servo control device, the machining result evaluation device comprising: a numerical control simulation unit to simulate an operation of a numerical control device that controls the servo control device, and output a position command to a drive shaft of the machine tool; a servo control simulation unit to simulate an operation of the servo control device on a basis of the position command, and output a torque command to the drive shaft; a drive shaft simulation unit to simulate an operation of the drive shaft on a basis of the torque command; and a machining result evaluation unit to evaluate the machining result on a basis of information corresponding to an operation of the drive shaft, wherein the drive shaft simulation unit outputs, to the servo control simulation unit, position information indicating a position of the drive shaft, the servo control simulation unit simulates feedback control of the drive shaft simulation unit by using the position information, and the machining result evaluation unit evaluates the machining result obtained when the feedback control of the drive shaft simulation unit is simulated.

### Effects of the Invention

The machining result evaluation device according to the present disclosure has an advantageous effect of accurately evaluating a machining result.

### BRIEF DESCRIPTION OF DRAWINGS

FIG. 1 is a block diagram illustrating a configuration of a machining result evaluation system including a machining result evaluation device according to a first embodiment.

FIG. 2 is a view for explaining an example of a process to be simulated by the machining result evaluation device according to the first embodiment.

FIG. 3 is a flowchart illustrating a processing procedure of a process to be executed by the machining result evaluation device according to the first embodiment.

FIG. 4 is a diagram illustrating an example configuration of processing circuitry when the processing circuitry of the machining result evaluation device according to the first embodiment is implemented by an arithmetic device and a memory.

FIG. 5 is a diagram illustrating an example of processing circuitry when the processing circuitry of the machining result evaluation device according to the first embodiment is configured by dedicated hardware.

FIG. 6 is a block diagram illustrating a configuration of a machining condition determination device according to a second embodiment.

FIG. 7 is a block diagram illustrating a configuration of a machining condition determination unit when the machining condition determination device according to the second embodiment calculates a machining condition corresponding to a machining result by using an inference model.

FIG. 8 is a block diagram illustrating a configuration of a machine learning device according to the second embodiment.

FIG. 9 is a diagram for explaining an example of a neural network used by the machine learning device according to the second embodiment.

FIG. 10 is a flowchart illustrating a processing procedure of a process to be executed by the machining condition determination device according to the second embodiment.

### DESCRIPTION OF EMBODIMENTS

A machining result evaluation device, a machining result evaluation method, a machining condition determination device, and a machining condition determination method according to embodiments of the present disclosure will be hereinafter described in detail with reference to the drawings.

### First Embodiment

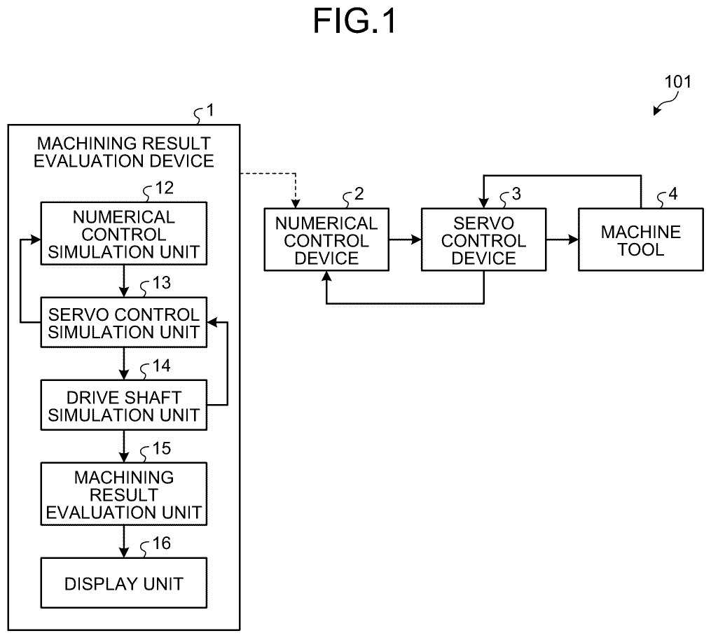

FIG. 1 is a block diagram illustrating a configuration of a machining result evaluation system including a machining result evaluation device according to a first embodiment. A machining result evaluation system 101 includes a machining result evaluation device 1, a numerical control device 2, a servo control device 3, and a machine tool 4.

In the machining result evaluation system 101, the numerical control device 2 outputs a position command, and the servo control device 3 controls a drive shaft of the machine tool 4 so as to follow the position command, thereby executing cutting machining.

In the cutting machining, the drive shaft of the machine tool 4 operates to thereby move a tool attached to a spindle of the machine tool 4 and a workpiece (object to be machined) fixed to a table or a turning spindle of the machine tool 4. In the cutting machining, the spindle or the turning spindle rotates to thereby rotate the tool or the workpiece, and the tool comes into contact with the workpiece, so that the tool cuts off a part of the workpiece.

The numerical control device 2 analyzes a command code described in a machining program, and outputs the position command to the servo control device 3 on the basis of the command code.

The servo control device 3 controls the drive shaft connected thereto via a motor of the machine tool 4 on the basis of the position command received from the numerical control device 2. In addition, the servo control device 3 performs feedback control. Specifically, the servo control device 3 performs feedback control so as to reduce a deviation between a position detected by a detector (not illustrated) from the drive shaft and the position command received from the numerical control device 2, and carries a current to the motor to control the drive shaft.

The machining result evaluation device 1 is a computer that evaluates a machining result of machining by the machine tool 4. An example of the machining performed by the machine tool 4 is cutting machining. The machining result evaluation device 1 includes a numerical control simulation unit 12, a servo control simulation unit 13, a drive shaft simulation unit 14, a machining result evaluation unit 15, and a display unit 16.

The numerical control simulation unit 12 simulates a process that is to be executed by the numerical control device 2. Specifically, the numerical control simulation unit 12 analyzes a command code described in the machining program and outputs a position command to the servo control simulation unit 13.

The servo control simulation unit 13 simulates a process that is to be executed by the servo control device 3. Specifically, the servo control simulation unit 13 performs feedback control so as to reduce a deviation between the position command received from the numerical control simulation unit 12 and the detected position received from the drive shaft simulation unit 14, and outputs a torque command to the drive shaft simulation unit 14.

The drive shaft simulation unit 14 simulates an operation of the drive shaft on the basis of a drive shaft model that models an operation of the drive shaft of the machine tool 4. Specifically, the drive shaft simulation unit 14 simulates a movement of the drive shaft of the machine tool 4 on the basis of the torque command received from the servo control simulation unit 13 and a response characteristic (for example, a transfer function) for the torque command. In addition, the drive shaft simulation unit 14 calculates and outputs position information indicating the detected position of the drive shaft to the servo control simulation unit 13. Since the tool is driven by the drive shaft, a position of the drive shaft corresponds to a position of the tool.

As described above, the numerical control simulation unit 12 calculates and outputs the position command to the drive shaft of the machine tool 4, by simulating the operation of the numerical control device 2 that controls the servo control device 3. In addition, the servo control simulation unit 13 calculates and outputs the torque command to the drive shaft, by simulating the operation of the servo control device 3 on the basis of the position command. In addition, the drive shaft simulation unit 14 simulates the operation of the drive shaft on the basis of the torque command, and calculates the position information on the drive shaft corresponding to the operation of the drive shaft. The drive shaft simulation unit 14 outputs the calculated position information to the servo control simulation unit 13 and the machining result evaluation unit 15.

The detector that detects a position of the drive shaft is a scale, in which case the drive shaft simulation unit 14 outputs position information on the drive shaft as it is to the servo control simulation unit 13 and the machining result evaluation unit 15. Further, the detector is an encoder that detects a rotation angle of the motor, in which case the drive shaft simulation unit 14 outputs position information obtained by converting a position of the drive shaft into a rotation angle, to the servo control simulation unit 13 and the machining result evaluation unit 15. For example, the drive shaft is a feed screw mechanism, in which case the drive shaft simulation unit 14 can obtain a rotation angle by dividing a position of the drive shaft by a pitch of a feed screw.

The servo control simulation unit 13 simulates feedback control on the drive shaft simulation unit 14, using the position information from the drive shaft simulation unit 14. The servo control simulation unit 13 uses the position information received from the drive shaft simulation unit 14 for simulation of feedback control, and outputs the position information as a feedback position to the numerical control simulation unit 12.

The numerical control simulation unit 12 simulates feedback control on the servo control simulation unit 13, using the position information from the servo control simulation unit 13. That is, the numerical control simulation unit 12 simulates a process that functions on the basis of the feedback position (position information) received from the servo control simulation unit 13.

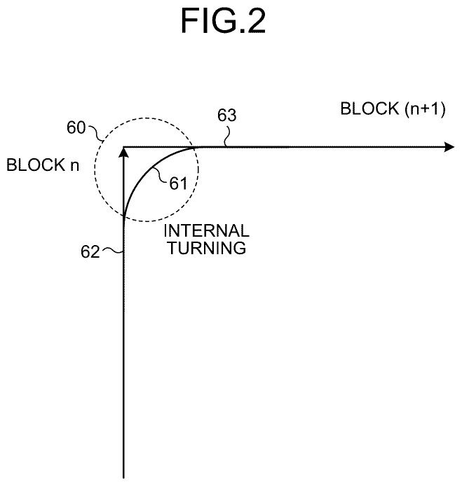

FIG. 2 is a view for explaining an example of a process to be simulated by the machining result evaluation device according to the first embodiment. A description will be made herein as to the machine tool 4 moving the tool along a straight line 62 of a block n (n is a natural number), and subsequently along a straight line 63 of a block (n+1) which is a next block. The two straight lines 62 and 63 are orthogonal to each other.

As illustrated in FIG. 2, the machine tool 4 moves the tool through a corner portion 60 at which the two straight lines 62 and 63 perpendicularly intersect, in which case the movement in the next block (n+1) usually starts before the tool reaches the intersection of the two straight lines 62 and 63 in this corner portion 60, such that the tool may turn internally. FIG. 2 indicates a path 61 along which the tool turns internally.

For the internal turning of the tool, the numerical control device 2 can prevent the internal turning by using an exact stop function of not starting movement in the next block (n+1) until conducting “in-position check”, i.e., checking that a remaining distance in the previous block n before the start of the next block (n+1) is within a certain range.

The numerical control device 2 executes the in-position check on the basis of the position information (feedback position) received from the servo control device 3. In view of this, the numerical control simulation unit 12 of the present embodiment simulates the exact stop function by receiving the position information from the servo control simulation unit 13.

The numerical control simulation unit 12 can accurately evaluate the machining result (machining accuracy) at the corner portion 60 by simulating the in-position check. Whereas, a machining result evaluation device that fails to simulate the in-position check fails to accurately evaluate the machining result of the corner portion 60.

In addition, since the numerical control simulation unit 12 simulates the in-position check, it is possible to simulate the path 61 identical to that of actual machining, thereby making it possible to estimate machining time equal to that of the actual machining. Whereas, the machining result evaluation device that fails to simulate the in-position check simulates the tool turning internally more than actual machining, so that the machining result evaluation device may estimate the machining time shorter than the actual machining.

In addition, the numerical control device 2 receives the rotation angle of the spindle and the position information of the drive shaft from the servo control device 3, thereby providing a function called a synchronous tap that performs tap machining in synchronization of rotation of the spindle with feeding of the drive shaft. In view of this, the numerical control simulation unit 12 receives the rotation angle of the spindle and the position information of the drive shaft from the servo control simulation unit 13, and simulates the synchronous tap on the basis of the rotation angle of the spindle and the position information on the drive shaft. As a result, the numerical control simulation unit 12 can accurately evaluate whether a tap hole has been accurately machined. Whereas, since a machining result evaluation device that does not receive the rotation angle of the spindle and the position information on the drive shaft cannot simulate the synchronous tap, it is not possible to accurately evaluate whether the tap hole has been accurately machined.

As described above, the process of the numerical control simulation unit 12 that functions on the basis of the position information received from the servo control simulation unit 13 may affect machining results such as machining accuracy and machining time. In order to accurately evaluate the machining result, therefore, it is necessary to accurately simulate the process functioning in actual machining, as does the numerical control simulation unit 12.

The drive shaft simulation unit 14 simulates an operation of the drive shaft, and outputs operation information indicating the operation of the drive shaft to the machining result evaluation unit 15. This operation information corresponds to an operation (movement path) of the tool. That is, the operation information includes position information on the drive shaft.

The machining result evaluation unit 15 evaluates the machining result on the basis of the operation information transmitted from the drive shaft simulation unit 14. The operation information transmitted from the drive shaft simulation unit 14 is operation information corresponding to a response of the servo control simulation unit 13 and a response of the drive shaft simulation unit 14. That is, the operation information transmitted from the drive shaft simulation unit 14 is information reflecting the position information transmitted from the servo control simulation unit 13 to the numerical control simulation unit 12 and the position information transmitted from the drive shaft simulation unit 14 to the servo control simulation unit 13. The machining result evaluation unit 15 therefore evaluates the machining result corresponding to the response of the servo control simulation unit 13 and the response of the drive shaft simulation unit 14.

As described above, the machining result evaluation unit 15 evaluates the machining result on the basis of the operation information when feedback control on the servo control simulation unit 13 and feedback control on the drive shaft simulation unit 14 are simulated. Note that the machining result evaluation unit 15 may evaluate the machining result on the basis of information transmitted from the numerical control simulation unit 12 or the servo control simulation unit 13.

Note that the operation information transmitted from the drive shaft simulation unit 14 may be operation information corresponding to a response of the drive shaft simulation unit 14. That is, the operation information transmitted from the drive shaft simulation unit 14 may be information that does not reflect the position information transmitted from the servo control simulation unit 13 to the numerical control simulation unit 12. In this case, the machining result evaluation unit 15 evaluates the machining result corresponding to the response of the drive shaft simulation unit 14.

Note that the machining result evaluation unit 15 may evaluate the machining result on the basis of at least one of data output from the numerical control simulation unit 12 to the servo control simulation unit 13 or data output from the servo control simulation unit 13 to the drive shaft simulation unit 14.

The machining result evaluated by the machining result evaluation unit 15 includes at least one of machining time, machining accuracy, machined surface quality, or power consumption, of machining by the machine tool 4. The power consumption is power consumed when the tool is driven.

When evaluating the machining time, the machining result evaluation unit 15 can estimate the machining time on the basis of at least one piece of data (response result) among: data (position command) output from the numerical control simulation unit 12; a response (detected position) of the servo control simulation unit 13; and a response (detected position) of the drive shaft simulation unit 14. The machining result evaluation unit 15 can estimate the machining time by calculating a sum of cycles (time periods) between the data on the position command or the detected position. That is, the machining result evaluation unit 15 can estimate the machining time by multiplying the number of data points at positions indicated by the position command or the detected positions, by an output cycle of the data.

When evaluating the machining accuracy and the machined surface quality, the machining result evaluation unit 15 moves the tool on a virtual space along at least one piece of data (response result) among: data (position command) output from the numerical control simulation unit 12; a response (detected position) of the servo control simulation unit 13; and a response (detected position) of the drive shaft simulation unit 14. The machining result evaluation unit 15 can estimate a shape of a machined workpiece after machining by performing machining simulation for removing, from the workpiece, a region through which the tool passes. That is, the machining result evaluation unit 15 calculates the shape of the machined workpiece by removing the region through which the workpiece passes from the region where the workpiece is disposed.

When evaluating the power consumption, the machining result evaluation unit 15 calculates a speed of the drive shaft on the basis of at least one piece of data (response result) among: data (position command) output from the numerical control simulation unit 12; a response (detected position) of the servo control simulation unit 13; and a response (detected position) of the drive shaft simulation unit 14. The machining result evaluation unit 15 can estimate the power consumption of the motor by multiplying the torque command output by the servo control simulation unit 13 to the drive shaft simulation unit 14, by the speed of the drive shaft.

The machining result evaluation unit 15 transmits the estimated machining result (at least one of the machining time, the machining accuracy, the machined surface quality, or the power consumption) to the display unit 16. The display unit 16 displays the machining result evaluated by the machining result evaluation unit 15.

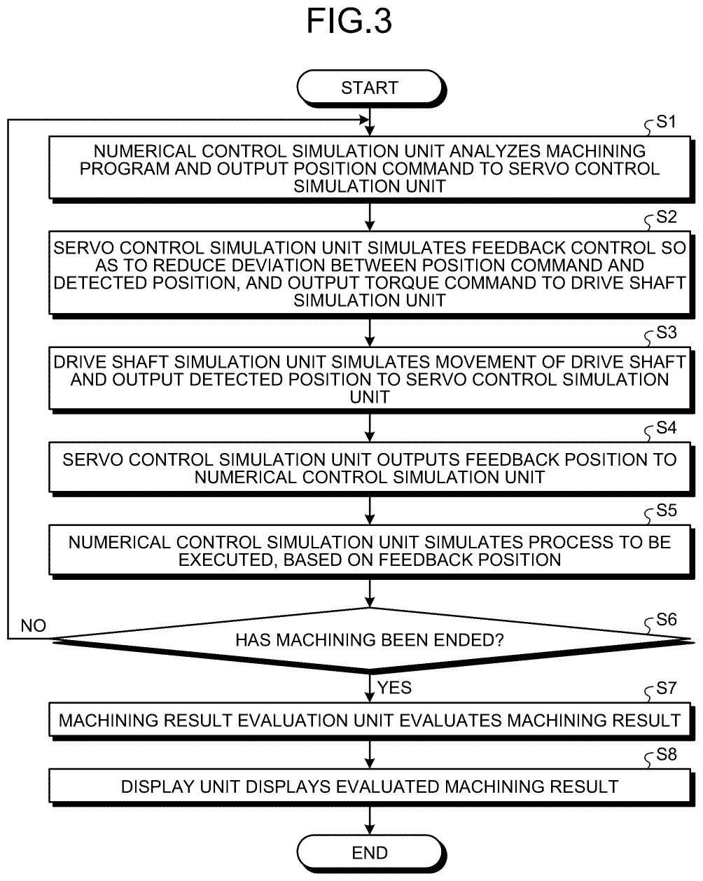

FIG. 3 is a flowchart illustrating a processing procedure of a process to be executed by the machining result evaluation device according to the first embodiment. The numerical control simulation unit 12 analyzes a command code described in the machining program, calculates a position command corresponding to the command code, and outputs the position command to the servo control simulation unit 13 (step S1).

The servo control simulation unit 13 simulates feedback control so as to reduce a deviation between the position command received from the numerical control simulation unit 12 and the detected position received from the drive shaft simulation unit 14, calculates a torque command corresponding to the feedback control, and outputs the torque command to the drive shaft simulation unit 14 (step S2).

The drive shaft simulation unit 14 simulates a movement of the drive shaft on the basis of the torque command received from the servo control simulation unit 13 and the response characteristic for the torque command, calculates position information indicating a position of the drive shaft as a detected position corresponding to the movement of the drive shaft, and outputs the position information to the servo control simulation unit 13 (step S3). In addition, the drive shaft simulation unit 14 outputs, to the machining result evaluation unit 15, operation information corresponding to the position information on the drive shaft.

The servo control simulation unit 13 calculates a feedback position (position information) corresponding to the detected position received from the drive shaft simulation unit 14, and outputs the feedback position to the numerical control simulation unit 12 (step S4).

The numerical control simulation unit 12 simulates a process to be executed by the numerical control device 2, on the basis of the feedback position received from the servo control simulation unit 13 (step S5). In other words, the numerical control simulation unit 12 simulates a process that functions on the basis of the feedback position received from the servo control simulation unit 13.

As described above, the machining result evaluation device 1 simulates feedback control based on the feedback position.

The machining result evaluation device 1 determines whether machining in the machining simulation has been ended (step S6). When machining is not ended (Step S6, No), the machining result evaluation device 1 returns to the process of step S1, and repeats simulation (processes of steps S1 to S6) until machining is ended.

When the machining is ended (Step S6, Yes), the machining result evaluation unit 15 evaluates the machining result on the basis of the operation information transmitted from the drive shaft simulation unit 14 (step S7). In this case, the machining result evaluation unit 15 evaluates the machining result on the basis of at least one among: data output from the numerical control simulation unit 12 to the servo control simulation unit 13; data output from the servo control simulation unit 13 to the drive shaft simulation unit 14; data (operation information) output from the drive shaft simulation unit 14 to the machining result evaluation unit 15; a response of the servo control simulation unit 13; and a response of the drive shaft simulation unit 14.

Note that the machining result evaluation device 1 may simulate machining, evaluating the machining result with the machining result evaluation unit 15. That is, the machining result evaluation unit 15 may evaluate the machining result each time data is output from the numerical control simulation unit 12, the servo control simulation unit 13, or the drive shaft simulation unit 14. The machining result evaluation unit 15 transmits the evaluated machining result to the display unit 16.

The display unit 16 displays the machining result evaluated by the machining result evaluation unit 15 (step S8). As a result, an operator can refer to the machining result. The operator changes settings (machining parameters, etc.) of the numerical control device 2 on the basis of the machining result, and operates the numerical control device 2 with the changed settings.

As described above, in the machining result evaluation device 1 according to the first embodiment, the drive shaft simulation unit 14 transmits a response to the servo control simulation unit 13, thereby enabling the servo control simulation unit 13 to accurately simulate the process functioning in actual machining. Further, in the machining result evaluation device 1, the servo control simulation unit 13 transmits a response to the numerical control simulation unit 12, thereby enabling the numerical control simulation unit 12 to accurately simulate the process functioning in actual machining. The machining result evaluation device 1 according to the first embodiment can therefore accurately evaluate the machining result.

Next, a hardware configuration of the machining result evaluation device 1 will be described. In the machining result evaluation device 1, the numerical control simulation unit 12, the servo control simulation unit 13, the drive shaft simulation unit 14, the machining result evaluation unit 15, and the display unit 16 are implemented by processing circuitry. This processing circuitry may be a memory and a processor that executes a program stored in the memory, or may be dedicated hardware. The processing circuitry is also referred to as a control circuit.

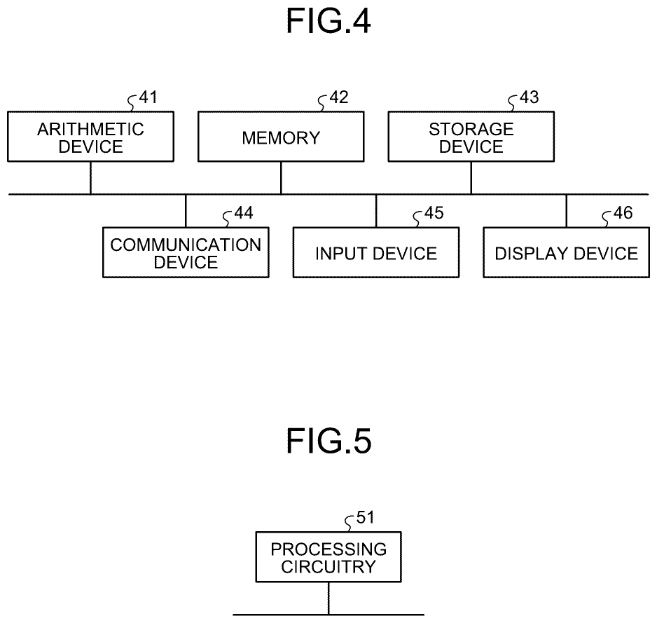

FIG. 4 is a diagram illustrating an example configuration of processing circuitry when the processing circuitry of the machining result evaluation device according to the first embodiment is implemented by an arithmetic device and a memory. FIG. 4 illustrates a hardware configuration for implementing the machining result evaluation device 1 according to the first embodiment.

The machining result evaluation device 1 includes an arithmetic device 41 which is a processor to performs arithmetic processing, a memory 42 which is used for a work area by the arithmetic device 41, a storage device 43 which stores a program and data, a communication device 44 which communicates with the outside, an input device 45 which receives an input from an operator, and a display device 46.

Examples of the arithmetic device 41 are a central processing unit (CPU), a processing device, a microprocessor, or a digital signal processor (DSP). An example of the memory 42 is a semiconductor memory. The storage device 43 is, for example, a nonvolatile or volatile semiconductor memory such as a random access memory (RAM), a read only memory (ROM), a flash memory, an erasable programmable read only memory (EPROM), or an electrically erasable programmable read-only memory (EEPROM) (registered trademark), a magnetic disk, a flexible disk, an optical disk, a compact disk, a mini disk, a digital versatile disk (DVD), or the like.

A machining result evaluation program stored in the storage device 43 is a program that causes the arithmetic device 41 to execute a procedure or a method to be executed by the numerical control simulation unit 12, the servo control simulation unit 13, the drive shaft simulation unit 14, and the machining result evaluation unit 15. That is, functions of the numerical control simulation unit 12, the servo control simulation unit 13, the drive shaft simulation unit 14, and the machining result evaluation unit 15 are implemented by the arithmetic device 41 executing the machining result evaluation program stored in the storage device 43.

Some functions of the display unit 16 are also implemented by the arithmetic device 41 which executes a display program stored in the storage device 43. The storage device 43 is also a device for storing the display program for implementing some functions of the display unit 16. That is, the storage device 43 also stores a display program for causing the arithmetic device 41 to execute a part of the procedure or the method to be executed by the display unit 16.

Examples of the input device 45 are some or all of a keyboard, a pointing device, and a mouse. The display device 46 is a means that implements the display unit 16. An example of the display device 46 is a liquid crystal display device. The input device 45 and the display device 46 may be integrated. Specifically, the input device 45 and the display device 46 may be implemented by a touch panel.

FIG. 5 is a diagram illustrating an example of processing circuitry when the processing circuitry of the machining result evaluation device according to the first embodiment is configured by dedicated hardware. FIG. 5 illustrates processing circuitry 51 when some or all of the numerical control simulation unit 12, the servo control simulation unit 13, the drive shaft simulation unit 14, the machining result evaluation unit 15, and the display unit 16 included in the machining result evaluation device 1 according to the first embodiment are implemented by the processing circuitry.

The processing circuitry 51 is dedicated hardware. The processing circuitry 51 is, for example, a single circuit, a composite circuit, a programmed processor, a parallel-programmed processor, an application specific integrated circuit (ASIC), a field-programmable gate array (FPGA), or a combination thereof.

Some of a plurality of functions of the numerical control simulation unit 12, the servo control simulation unit 13, the drive shaft simulation unit 14, the machining result evaluation unit 15, and the display unit 16 may be implemented by software or firmware, and the rest of the plurality of functions may be implemented by dedicated hardware. As described above, the plurality of functions of the numerical control simulation unit 12, the servo control simulation unit 13, the drive shaft simulation unit 14, the machining result evaluation unit 15, and the display unit 16 can be realized by hardware, software, firmware, or a combination thereof. Note that, some of the servo control simulation unit 13, the drive shaft simulation unit 14, the machining result evaluation unit 15, and the display unit 16 may be implemented by separate processing circuitries.

The machining result evaluation device 1 may be incorporated in the numerical control device 2, or may be connected to the numerical control device 2 via a communication network. Alternatively, the machining result evaluation device 1 may be mounted on a server or a cloud.

As described above, in the machining result evaluation device 1 of the first embodiment, the drive shaft simulation unit 14 outputs the position information indicating the position of the drive shaft to the servo control simulation unit 13, and the servo control simulation unit 13 simulates the feedback control on the drive shaft simulation unit 14 by using the position information. Then, the machining result evaluation unit 15 evaluates the machining result on the basis of operation information, etc. obtained when the feedback control on the drive shaft simulation unit 14 is simulated. As a result, the machining result evaluation device 1 can accurately simulate the process functioning in actual machining, and thus can accurately evaluate machining results such as machining accuracy and machining time.

Further, in the machining result evaluation device 1, the servo control simulation unit 13 outputs the position information to the numerical control simulation unit 12, and the numerical control simulation unit 12 simulates feedback control on the servo control simulation unit 13 by using the position information. Then, the machining result evaluation unit 15 evaluates the machining result on the basis of operation information, etc. obtained when the feedback control on the servo control simulation unit 13 and the feedback control on the drive shaft simulation unit 14 are simulated. As a result, the machining result evaluation device 1 can more accurately simulate the process functioning in actual machining, and thus can more accurately evaluate machining results such as machining accuracy and machining time.

### Second Embodiment

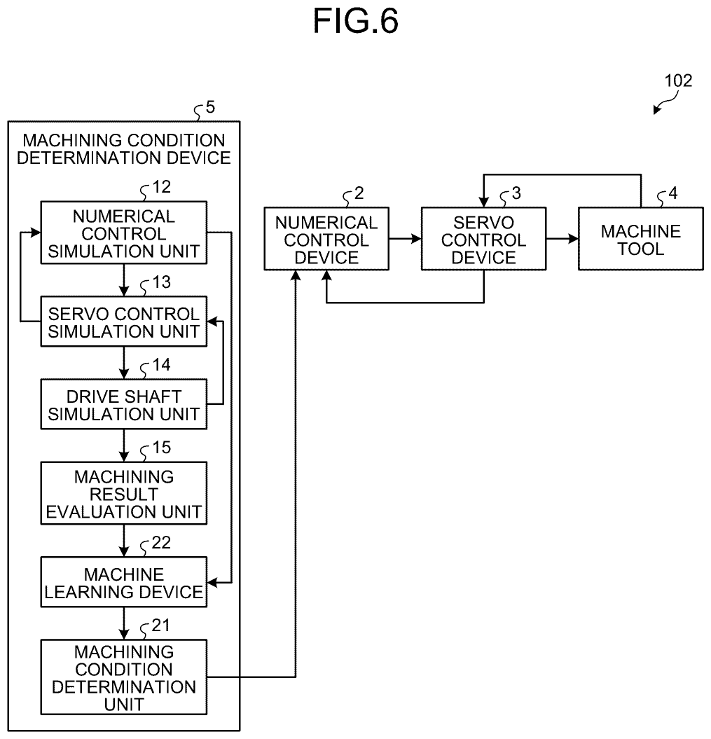

Next, a second embodiment will be described with reference to FIGS. 6 to 9. In the second embodiment, a correspondence between a machining result and a machining condition is learned in advance, and a machining condition corresponding to a machining result is determined.

FIG. 6 is a block diagram illustrating a configuration of a machining condition determination device according to the second embodiment. Among the individual components in FIG. 6, components that achieve functions identical to those of the machining result evaluation device 1 of the first embodiment illustrated in FIG. 1 are denoted by the identical reference numerals, and redundant descriptions will be omitted. A machining condition determination system 102 includes a machining condition determination device 5, the numerical control device 2, the servo control device 3, and the machine tool 4.

The machining condition determination device 5 according to the second embodiment includes the numerical control simulation unit 12, the servo control simulation unit 13, the drive shaft simulation unit 14, and the machining result evaluation unit 15, all of which are included in the machining result evaluation device 1 according to the first embodiment. Further, the machining condition determination device 5 according to the second embodiment does not include the display unit 16 of the machining result evaluation device 1 according to the first embodiment. The machining condition determination device 5 according to the second embodiment includes a machine learning device 22 and a machining condition determination unit 21, both of which are not included in the machining result evaluation device 1 according to the first embodiment. That is, the machining condition determination device 5 includes the machine learning device 22 and the machining condition determination unit 21 instead of the display unit 16, as compared with the machining result evaluation device 1 according to the first embodiment. Note that the machining condition determination device 5 may include the display unit 16.

In the second embodiment, differences from the first embodiment will be mainly described. The machine learning device 22 receives a machining result output from the machining result evaluation unit 15. In addition, the machine learning device 22 receives a machining condition which the numerical control simulation unit 12 used for simulation. By performing machine learning so as to calculate a correspondence between the machining condition and the machining result, the machine learning device 22 generates an inference model (learned model). The machine learning device 22 transmits the generated inference model to the machining condition determination unit 21.

The machining condition determination unit 21 calculates an appropriate machining condition for a machining result input by the operator. The machining condition determination unit 21 calculates the machining condition corresponding to the machining result by using the inference model generated by the machine learning device 22.

The machining condition determination unit 21 outputs machining parameters included in the determined machining condition, to the numerical control device 2. As a result, the numerical control device 2 controls the servo control device 3 by using the machining parameters transmitted from the machining condition determination unit 21.

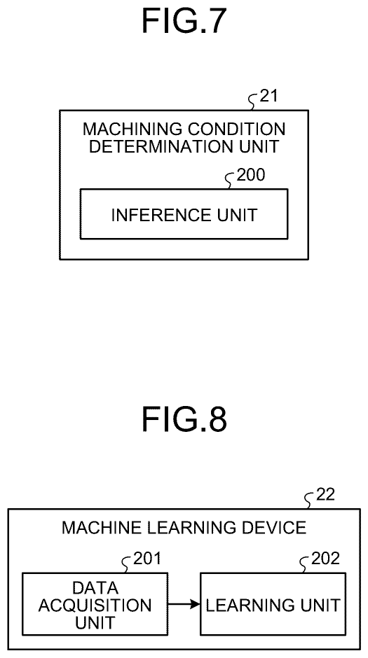

FIG. 7 is a block diagram illustrating a configuration of a machining condition determination unit when the machining condition determination device according to the second embodiment calculates a machining condition corresponding to a machining result by using the inference model. The machining condition determination unit 21 includes an inference unit 200. The inference unit 200 has a learned inference model subjected to machine learning so as to output a machining condition upon receiving an input of a machining result from the machining result evaluation unit 15. Specifically, when the machining result is input to the inference model subjected to machine learning in advance so as to output the machining condition, the inference unit 200 outputs the machining condition corresponding to the machining result.

The machining condition corresponding to the machining result is a machining condition that can reduce a difference between a desired machining result and a simulated machining result. That is, on the basis of the simulated machining result, the machining condition determination unit 21 calculates a machining condition under which a desired machining result can be obtained.

FIG. 8 is a block diagram illustrating a configuration of a machine learning device according to the second embodiment. The machine learning device 22 is a device that performs learning on the inference model, and learns a correspondence between a machining condition and a machining result. The machine learning device 22 includes a data acquisition unit 201 and a learning unit 202.

The data acquisition unit 201 acquires a combination of a machining condition and a machining result. Specifically, the data acquisition unit 201 acquires a combination of a machining condition and at least one of machining time, machining accuracy, machined surface quality, or power consumption.

The data acquisition unit 201 acquires the machining condition from the numerical control simulation unit 12, for example. Note that, the data acquisition unit 201 may acquire the machining condition from the servo control simulation unit 13 or the drive shaft simulation unit 14. In addition, the data acquisition unit 201 acquires, for example, a machining result corresponding to the machining condition from the machining result evaluation unit 15.

Note that, the data acquisition unit 201 may acquire the machining condition from the numerical control device 2. Further, the data acquisition unit 201 may acquire a machining result of a workpiece actually machined by the machine tool 4. The data acquisition unit 201 outputs a combination of the machining condition and the machining result to the learning unit 202.

The learning unit 202 learns a correspondence between a machining condition and a machining result, in accordance with a data set created on the basis of the combination of the machining condition and the machining result. Specifically, the learning unit 202 learns the correspondence between the machining condition and the machining result by using a data set created on the basis of a combination of the machining condition, the machining time, the machining accuracy, the machined surface quality, and the power consumption, all of which are output from the data acquisition unit 201. The data set is data in which a state variable and a machining condition are associated with each other. The state variable is at least one of the machining time, the machining accuracy, the machined surface quality, and the power consumption. The learning unit 202 adjusts the inference model so that the machining condition is output from the inference model when the state variable is input to the inference model. The learning unit 202 generates a learned inference model by learning a correspondence between the machining condition and the machining result.

The machine learning device 22 generates a learned inference model to be used by the machining condition determination device 5. That is, the machine learning device 22 is used to learn the machining condition calculated by the machining condition determination device 5 and corresponding to the machining time, the machining accuracy, the machined surface quality, and the power consumption. The machine learning device 22 may be a device separate from the machining condition determination device 5 or may be incorporated in the machining condition determination device 5. When the machine learning device 22 is a device separate from the machining condition determination device 5, the machine learning device 22 is connected to the machining condition determination device 5 via, for example, a communication network. Furthermore, the machine learning device 22 may be present on a server or a cloud. In addition, the machining condition determination unit 21 may be a device separate from the machining condition determination device 5, or may be incorporated in the machining condition determination device 5. When the machining condition determination unit 21 is a device separate from the machining condition determination device 5, the machining condition determination unit 21 is connected to the machining condition determination device 5 via, for example, a communication network. In addition, the machining condition determination unit 21 may be present on a server or a cloud.

For example, the learning unit 202 learns a correspondence between a machining condition and a machining result by so-called supervised learning in accordance with a neural network model. The supervised learning refers to a model that gives a learning device a large number of sets of data on a certain input and a result (label), thereby learning features in data sets and estimating a result from the input.

A neural network includes an input layer consisting of a plurality of neurons, an intermediate layer (hidden layer) made up of a plurality of neurons, and an output layer made up of a plurality of neurons. The intermediate layer may be a single layer or two or more layers.

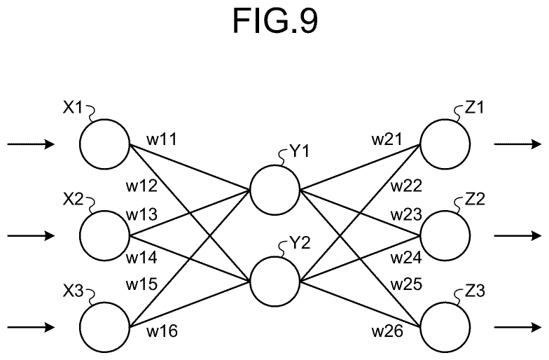

FIG. 9 is a diagram for explaining an example of a neural network used by the machine learning device according to the second embodiment. For example, in a three-layer neural network as illustrated in FIG. 9, when a plurality of inputs are input to an input layer (X1 to X3), a value obtained by multiplying an input value by a weight W1 (w11 to w16) is input to an intermediate layer (Y1 and Y2). A value obtained by multiplying the value input to the intermediate layer (Y1 and Y2) by a weight W2 (w21 to w26) is output from an output layer (Z1 to Z3). The output result varies depending on values of the weight W1 and the weight W2.

For example, the neural network learns a correspondence between a machining condition and a machining result by so-called supervised learning in accordance with a data set created on the basis of a combination of the machining condition, the machining time, the machining accuracy, the machined surface quality, and the power consumption, all of which are acquired by the data acquisition unit 201. That is, the neural network performs learning by adjusting the weight W1 and the weight W2 so that the result output from the output layer when the machining time, the machining accuracy, the machined surface quality, and the power consumption are input to the input layer approaches the machining condition.

The neural network may learn a correspondence between a machining condition and a machining result by so-called unsupervised learning. The unsupervised learning is a technique of giving a large amount of only input data to the machine learning device 22, thereby learning the distribution of the input data so as to learn a device that performs, for example, some or all of compression, classification, and shaping in response to the input data without being given the corresponding teacher output data. For example, the neural network can cluster features in a data set into similar ones. The neural network uses the obtained result and assigns outputs that optimize the result with some criteria, thereby performing the prediction of outputs.

There is learning called semi-supervised learning, as an intermediate problem setting between the unsupervised learning and the supervised learning. The semi-supervised learning is learning with sets of input and output data and input data alone.

The learning unit 202 may learn a correspondence between a machining condition and a machining result in accordance with data sets created for a plurality of machining condition determination devices 5. The learning unit 202 may acquire data sets from a plurality of machining condition determination devices 5 used in one site, or may learn a correspondence between a machining condition and a machining result by using data sets collected from a plurality of machining condition determination devices 5 operating independently in different sites.

The machining condition determination device 5 may be added at some midpoint as a target from which to collect data sets, or the machining condition determination device 5 may be removed such that the device 5 is no longer the target. The machine learning device 22 that has learned the correspondence between the machining condition and the machining result may be attached to another machining condition determination device 5 different from the device including that machine learning device 22, and may relearn and update the correspondence between the machining condition and the machining result for that different machining condition determination device 5.

Deep learning for learning extraction of a feature amount itself can be used as a learning algorithm used in the learning unit 202. The learning unit 202 may execute machine learning in accordance with other known methods, for example, genetic programming, functional logic programming, a support vector machine, etc.

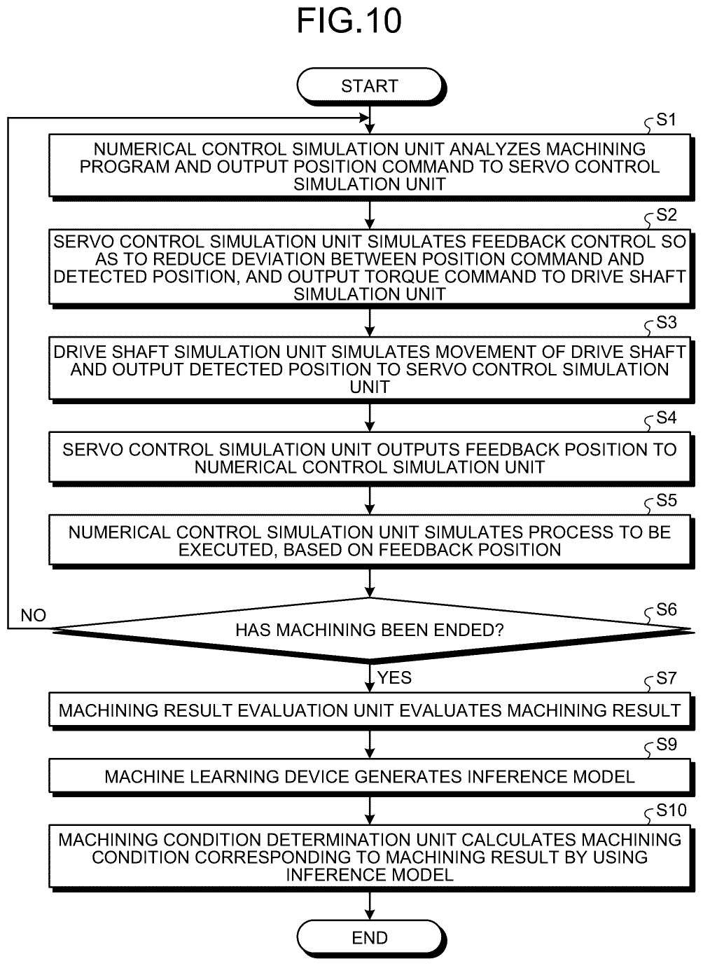

FIG. 10 is a flowchart illustrating a processing procedure of a process to be executed by the machining condition determination device according to the second embodiment. The machining condition determination device 5 executes a process similar to steps S1 to S7 executed by the machining result evaluation device 1 described with reference to FIG. 3.

In the machining condition determination device 5, the machining result evaluation unit 15 outputs the evaluated machining result to the machine learning device 22. The machine learning device 22 generates an inference model (inference unit 200) for calculation of a correspondence between a machining condition and a machining result (step S9). The machining condition determination unit 21 calculates a machining condition corresponding to the machining result by using the inference model (step S10).

The machining condition determination unit 21 outputs, to the numerical control device 2, machining parameters included in the determined machining condition. As a result, the numerical control device 2 controls the servo control device 3 by using the machining parameters transmitted from the machining condition determination unit 21.

As described above, the machining condition determination device 5 according to the second embodiment can accurately simulate the process functioning in actual machining, because the servo control simulation unit 13 transmits a response to the numerical control simulation unit 12. The machining condition determination device 5 according to the second embodiment can therefore accurately evaluate the machining result.

In addition, using the inference model that has learned a correspondence between a machining condition and an accurately evaluated machining result, the machining condition determination device 5 according to the second embodiment calculates a machining condition corresponding to a machining result. The machining condition determination device 5 calculates a machining condition corresponding to a machining result designated by the operator.

When calculating the machining condition corresponding to the machining result designated by the operator, the machining condition determination device 5 can determine a machining condition that satisfies a machining result desired by the operator. The machining condition determination device 5 according to the second embodiment can therefore determine the machining condition that satisfies the operator's desired machining result just by requiring the operator to input information indicating the desired machining result.

At least some of the functions of the machining condition determination unit 21 in the second embodiment may be implemented by an arithmetic device that executes a program stored in a storage device. The storage device is a storage device for storing a program that results in execution of at least some steps of the steps executed by the machining condition determination unit 21, and is a storage device similar to the storage device 43. The arithmetic device in this case is an arithmetic device similar to the arithmetic device 41. Further, at least some of the functions of the machining condition determination unit 21 may be implemented by processing circuitry. The processing circuitry is processing circuitry similar to the processing circuitry described with reference to FIG. 4 or the processing circuitry 51 described with reference to FIG. 5.

At least some of the functions of the inference unit 200 included in the machining condition determination unit 21 in the second embodiment may be implemented by an arithmetic device that executes a program stored in a storage device. The storage device is a storage device for storing a program that results in execution of at least some steps of the steps executed by the inference unit 200, and is a storage device similar to the storage device 43. The arithmetic device in this case is an arithmetic device similar to the arithmetic device 41. At least some of the functions of the inference unit 200 may be implemented by processing circuitry. The processing circuitry is processing circuitry similar to the processing circuitry described with reference to FIG. 4 or the processing circuitry 51 described with reference to FIG. 5.

At least some of the functions of the data acquisition unit 201 and the learning unit 202 included in the machine learning device 22 according to the second embodiment may be implemented by an arithmetic device that executes a program stored in a storage device. The storage device is a storage device for storing a program that results in execution of at least some steps of the steps executed by the data acquisition unit 201 and the learning unit 202, and is a storage device similar to the storage device 43. The arithmetic device in this case is an arithmetic device similar to the arithmetic device 41. At least some of the functions of the data acquisition unit 201 and the learning unit 202 may be implemented by processing circuitry. The processing circuitry is processing circuitry similar to the processing circuitry described with reference to FIG. 4 or the processing circuitry 51 described with reference to FIG. 5.

Further, at least some of the functions of the machining condition determination device 5 may be implemented by processing circuitry similar to the processing circuitry described with reference to FIG. 4 or the processing circuitry 51 described with reference to FIG. 5.

As described above, in the machining condition determination device 5 of the second embodiment, the drive shaft simulation unit 14 outputs, to the servo control simulation unit 13, position information indicating a position of the drive shaft, and the servo control simulation unit 13 simulates feedback control on the drive shaft simulation unit 14 by using the position information. Then, the machining result evaluation unit 15 evaluates a machining result on the basis of the operation information when the feedback control on the drive shaft simulation unit 14 is simulated. Further, the machine learning device 22 generates an inference model for inferring a machining condition from the machining result, and the machining condition determination unit 21 determines the machining condition corresponding to the machining result, by using the inference model. As a result, the machining condition determination device 5 can determine a machining condition corresponding to a machining result that accurately simulates the process functioning in actual machining.

Further, in the machining condition determination device 5, the servo control simulation unit 13 outputs the position information to the numerical control simulation unit 12, and the numerical control simulation unit 12 simulates feedback control on the servo control simulation unit 13 by using the position information. Then, the machining result evaluation unit 15 evaluates the machining result on the basis of operation information when the feedback control on the servo control simulation unit 13 and the feedback control on the drive shaft simulation unit 14 are simulated. As a result, the machining condition determination device 5 can more accurately simulate the process functioning in actual machining, and thus can more accurately determine the machining condition corresponding to the simulated machining result.

The configurations illustrated in the above embodiments illustrate one example and can be combined with another known technique, and it is also possible to combine embodiments with each other and omit and change a part of the configuration without departing from the subject matter of the present disclosure.

### REFERENCE SIGNS LIST

1 machining result evaluation device; 2 numerical control device; 3 servo control device; 4 machine tool; 5 machining condition determination device; 12 numerical control simulation unit; 13 servo control simulation unit; 14 drive shaft simulation unit; 15 machining result evaluation unit; 16 display unit; 21 machining condition determination unit; 22 machine learning device; 41 arithmetic device; 42 memory; 43 storage device; 44 communication device; 45 input device; 46 display device; 51 processing circuitry; 60 corner portion; 61 path; 62, 63 straight line; 101 machining result evaluation system; 102 machining condition determination system; 200 inference unit; 201 data acquisition unit; 202 learning unit.

1. A machining result evaluation device to evaluate a machining result of machining by a machine tool driven by a servo control device,
the machining result evaluation device comprising:
numerical control simulation circuitry to calculate a position command to a drive shaft of the machine tool by simulating an operation of a numerical control device that controls the servo control device, and output the calculated position command;
servo control simulation circuitry to calculate a torque command to the drive shaft by simulating an operation of the servo control device on a basis of the position command, and output the calculated torque command;
drive shaft simulation circuitry to simulate an operation of the drive shaft on a basis of the torque command; and
machining result evaluation circuitry to evaluate the machining result on a basis of information corresponding to an operation of the drive shaft, wherein
the drive shaft simulation circuitry outputs, to the servo control simulation circuitry, position information indicating a position of the drive shaft obtained by simulating the operation of the drive shaft,
the servo control simulation circuitry simulates feedback control of the drive shaft simulation circuitry by using the position information, and
the machining result evaluation circuitry evaluates the machining result obtained when the feedback control of the drive shaft simulation circuitry is simulated.

2. The machining result evaluation device according to claim 1, wherein:
information corresponding to an operation of the drive shaft is the position information, and
the machining result evaluation circuitry evaluates the machining result on a basis of the position information.

3. The machining result evaluation device according to claim 1, wherein:
the servo control simulation circuitry outputs the position information to the numerical control simulation circuitry,
the numerical control simulation circuitry simulates feedback control of the servo control simulation circuitry by using the position information, and
the machining result evaluation circuitry evaluates the machining result obtained when the feedback control of the servo control simulation circuitry and the feedback control of the drive shaft simulation circuitry are simulated.

4. The machining result evaluation device according to claim 3, wherein:
information corresponding to an operation of the drive shaft is the position information output by the servo control simulation circuitry to the numerical control simulation circuitry, and
the machining result evaluation circuitry evaluates the machining result on a basis of the position information output by the servo control simulation circuitry to the numerical control simulation circuitry.

5. The machining result evaluation device according to claim 3, wherein:
information corresponding to an operation of the drive shaft is the position command output by the numerical control simulation circuitry, and
the machining result evaluation circuitry evaluates the machining result on a basis of the position command output by the numerical control simulation circuitry.

6. The machining result evaluation device according to claim 1, wherein:
the machining result evaluation circuitry evaluates at least one of machining time, machining accuracy, machined surface quality, or power consumption, of machining by the machine tool.

7. A machining result evaluation method for evaluating a machining result of machining by a machine tool driven by a servo control device,
the machining result evaluation method comprising:
calculating a position command to a draft shaft of the machine tool by simulating an operation of a numerical control device that controls the servo control device, and outputting the calculated position command to a drive shaft of the;
calculating a torque command to the drive shaft by simulating an operation of the servo control device on a basis of the position command, and outputting the calculated torque command;
simulating an operation of the drive shaft on a basis of the torque command and outputting operation information indicating the operation of the drive shaft; and
evaluating the machining result on a basis of information corresponding to an operation of the drive shaft, wherein
the method further comprises:
outputting position information indicating a position of the drive shaft obtained by simulating the operation of the drive shaft:
simulating feedback control of the drive shaft by using the position information; and
evaluating the machining result obtained when the feedback control of the drive shaft is simulated.

8. The machining result evaluation method according to claim 7, further comprising:
simulates simulating feedback control of the servo control device by using the position information; and
evaluating the machining result of when the feedback control of the servo control device and the feedback control of the drive shaft are simulated.

9. A machining condition determination device to determine a machining condition when a machine tool driven by a servo control device performs machining,
the machining condition determination device comprising:
numerical control simulation circuitry to calculate a position command to a drive shaft of the machine tool by simulating an operation of a numerical control device that controls the servo control device, and output the calculated position command;
servo control simulation circuitry to calculate a torque command to the drive shaft by simulating an operation of the servo control device on a basis of the position command, and output the calculated torque command;
drive shaft simulation circuitry to simulate an operation of the drive shaft on a basis of the torque command, and output operation information indicating an operation of the drive shaft;
machining result evaluation circuitry to evaluate a machining result of machining by the machine tool on a basis of information corresponding to an operation of the drive shaft;
machine learning circuitry to generate an inference model for inferring the machining condition from the machining result; and
machining condition determination circuitry to determine a machining condition by using the inference model, the machining condition corresponding to a machining result input by an operator, wherein
the drive shaft simulation circuitry outputs, to the servo control simulation circuitry, position information indicating a position of the drive shaft obtained by simulating the operation of the drive shaft,
the servo control simulation circuitry simulates feedback control of the drive shaft simulation circuitry by using the position information, and
the machining result evaluation circuitry evaluates the machining result obtained when the feedback control of the drive shaft simulation circuitry is simulated.

10. The machining condition determination device according to claim 9, wherein
the servo control simulation circuitry outputs the position information to the numerical control simulation circuitry,
the numerical control simulation circuitry simulates feedback control of the servo control simulation circuitry by using the position information, and
the machining result evaluation circuitry evaluates the machining result obtained when the feedback control of the servo control simulation circuitry and the feedback control of the drive shaft simulation circuitry are simulated.

11. A machining condition determination method for determining a machining condition when a machine tool driven by a servo control device performs machining,
the machining condition determination method comprising:
calculating a positon command to a drive shaft of the machine tool by simulating an operation of a numerical control device that controls the servo control device, and outputting the calculated position command;
calculating a torque command to the drive shaft by simulating an operation of the servo control device on a basis of the position command, and outputting the calculated torque command;
simulating an operation of the drive shaft on a basis of the torque command, and outputting operation information indicating an operation of the drive shaft;
evaluating a machining result of machining by the machine tool on a basis of information corresponding to an operation of the drive shaft;
generating an inference model for inferring the machining condition from the machining result; and
determining a machining condition by using the inference model, the machining condition corresponding to a machining result input by an operator, wherein
the method further comprises:
outputting position information indicating a position of the drive shaft obtained by simulating the operation of the drive shaft;
simulating feedback control of the drive shaft by using the position information; and
evaluating the machining result obtained when the feedback control of the drive shaft is simulated.

12. The machining condition determination method according to claim 11, further comprising:
simulating feedback control of the servo control device by using the position information; and
evaluating the machining result obtained when the feedback control of the servo control device and the feedback control of the drive shaft are simulated.

13. The machining result evaluation device according to claim 2, wherein:
the machining result evaluation circuitry evaluates at least one of machining time, machining accuracy, machined surface quality, or power consumption, of machining by the machine tool.

14. The machining result evaluation device according to claim 3, wherein:
the machining result evaluation circuitry evaluates at least one of machining time, machining accuracy, machined surface quality, or power consumption, of machining by the machine tool.

15. The machining result evaluation device according to claim 4, wherein:
the machining result evaluation circuitry evaluates at least one of machining time, machining accuracy, machined surface quality, or power consumption, of machining by the machine tool.

16. The machining result evaluation device according to claim 5, wherein:
the machining result evaluation circuitry evaluates at least one of machining time, machining accuracy, machined surface quality, or power consumption, of machining by the machine tool.
